(19) United States
(12) Patent Application Publication
(10) Pub. No.: US 2026/0301252 A1
(43) Pub. Date: Oct. 1, 2026

(54) INTERPRETING PATENTS USING RETRIEVAL-AUGMENTED GENERATION AND LANGUAGE MODELS

(71) Applicant: Xin Gao, Hayward, CA (US)

(72) Inventor: Xin Gao, Hayward, CA (US)

(21) Appl. No.: 19/632,439

(22) Filed: Mar. 30, 2026

Related U.S. Application Data
(60) Provisional application No. 63/780,396, filed on Mar. 30, 2025.

(51) Int. Cl. G06T 11/26; G06F 16/334; G06F 16/35; G06Q 50/18

(52) U.S. Cl. CPC G06T 11/26; G06F 16/3344; G06F 16/35; G06Q 50/184; G06F 2216/11

(57) ABSTRACT

Herein describes a method and system for determining patent coverage, comprising: interpreting a patent document using at least one first computational model trained with a collection of patent data; generating at least one scope representation based on the interpretation, wherein said at least one scope representation comprises one or more claim elements corresponding to the patent document; mapping said least one scope representation to a product or service using at least one second computational model trained with data on products and services in relation to the collection of patent data, wherein the mapping comprises at least one data structure associated with a claim format; and outputting a data representation of the patent coverage for the patent document based on the mapping.

### FIELD

The present invention relates to a method and system for determining patent coverage using one or more computational models.

### BACKGROUND

Language models are computational models built on transformer architectures, trained on extensive text data to perform tasks like text generation, question answering, and sentiment analysis. These models understand contextual relationships between words, enabling them to generate coherent and relevant text across various topics. Their versatility makes them suitable for applications in conversational AI, content creation, and knowledge extraction.

In intellectual property, especially patent analysis, traditional methods such as manual reviews and basic keyword searches are time-consuming and prone to errors. By integrating Retrieval-Augmented Generation (RAG) or similar approaches, computational models such as LLMs can access up-to-date, domain-specific information, enabling more accurate and efficient patent claim interpretation, prior art searches, and portfolio management. This enhances the scalability, consistency, and speed of decision-making in intellectual property tasks.

The disadvantages of the traditional approaches mentioned above are not necessarily addressed by all aspects and embodiments described below, which May offer alternative solutions and improvements.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present disclosure comprising a method and system for determining patent coverage using advanced computational models that integrate the interpretation of patent documents, the generation of structured scope representations based on claim elements or features, and the mapping of these representations to corresponding products or services. In particular, the invention provides a unified approach that leverages machine learning techniques, including large language models (LLMs) and retrieval-augmented generation (RAG), to extract and process key patent claim elements, generate data structures in a standardized claim format, and dynamically incorporate external contextual data. This integrated system enhances the accuracy, scalability, and efficiency of patent analysis by streamlining tasks such as prior art searches, infringement assessments, and portfolio management, thereby overcoming the limitations of traditional, manual patent examination methods.

In a first aspect is a method or computer-implemented method for (of) determining patent coverage, comprising: interpreting a patent document using at least one first computational model trained with a collection of patent data; generating at least one scope representation based on the interpretation, wherein said at least one scope representation comprises one or more claim elements corresponding to the patent document; mapping said least one scope representation to a product or service using at least one second computational model trained with data on products and services in relation to the collection of patent data, wherein the mapping comprises at least one data structure associated with a claim format; and outputting a data representation of the patent coverage for the patent document based on the mapping.

In a second aspect is a system for determining patent coverage, wherein the system comprises one or more modules, comprising: at least one first computational model trained with a collection of patent data, wherein said at least one first computational model is configured to interpret a patent document and extract one or more claim elements; wherein said one or more modules are configured to generate at least one scope representation based on the interpretation, wherein said at least one scope representation comprises said one or more claim elements corresponding to the patent document; at least one second computational model trained with data on products and services in relation to the collection of patent data, wherein said at least one second computational model is configured to map said at least one scope representation to a product or service, said mapping comprising at least one data structure associated with a claim format; and wherein said one or more modules are further configured to output a data representation of the patent coverage for the patent document based on the mapping.

In a third aspect is an apparatus that manages data, comprising: a processor; and a memory, coupled to the processor, the memory comprising instructions that, when executed by the processor, cause the apparatus to perform the method steps according to one or more aspects and/or options described herein.

In a fourth aspect is a non-transitory machine-readable medium comprising instructions that, when executed by a machine, cause the machine to perform operations according to one or more aspects and/or options described herein.

In a fifth aspect a method for (of) training a computational model to interpret patent coverage of a patent document, comprising: receiving training data comprising one or more of patent documents, prior art references, publications, opinions, examination reports, and product or service catalogs; processing the training data based on one or more criteria associated by using one or more techniques of tokenization, entity recognition, and vector embedding generation; training the computational model using the processed training data, wherein the computational model is configured to distinguish claim elements, legal concepts, and technical descriptions, and generate a structured mapping between them; and generating a trained computational model configured to interpret the patent coverage of the patent document in accordance with claims one or more aspect and/or options described herein.

The methods described herein may be performed by software in machine-readable form on a tangible storage medium e.g. in the form of a computer program comprising computer program code means adapted to perform all the steps of any of the methods described herein when the program is run on a computer and where the computer program may be embodied on a computer-readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” hardware that is without built-in intelligence or processing ability, “smart” hardware that have built-in processing capabilities and can operate independently or adapt based on inputs, or any standard hardware as described herein, to carry out the desired functions. It is also intended to encompass software which “describes” or defines the configuration of hardware, such as HDL (hardware description language) software, as is used for designing silicon chips, or for configuring universal programmable chips, to carry out desired functions.

### DETAILED DESCRIPTION

Embodiments of the present invention are described below by way of example only. These examples represent the suitable modes of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The present invention relates to assessing patent coverage using computational models, specifically leveraging Large Language Models (LLMs) and Retrieval-Augmented Generation (RAG). The process involves interpreting a patent document using a (first) computational model trained on a collection of patent data. This computational model may be an LLM fine-tuned on patent documents, extracts key claim elements, legal concepts, and technical details. RAG can be used to retrieve relevant prior art, legal interpretations, or related patents from external databases, ensuring that the interpretation is informed by up-to-date information and improves accurate of the output. The retrieved data may be vectorized and represented as embeddings, which the LLM can process to understand the context of the patent, accounting for patent classifications, descriptions, and broader contextual information.

The computational models can be configured to generate a scope representation, which serves as a structured model of the patent coverage. This representation may comprise extracted claim elements, key technical features, and an assessment of legal scope based on a plausible claim construction. This representation may be presented as a natural language summary, a vector embedding for similarity analysis, a structured dataset, or a combination thereof. The models can be configured to retrieve in real-time similar claims from patent offices, legal opinions, or industry-specific documentation to refine this scope representation.

The computational models can also be configured to map the generated scope representation to a product or service using a second computational model. This model, which may be another LLM or a classification system, associates the extracted claim elements with known products and services. This mapping could involve text similarity comparisons with product descriptions, technical manuals, regulatory filings, or industry taxonomies. The claim mentions the use of a data structure associated with a claim format but does not specify whether this structure is predefined (such as IPC/CPC codes) or dynamically generated. RAG can retrieve external product databases or prior legal analyses to refine the mapping. The mapping can be purely textual, based on structured metadata, a hybrid approach incorporating various sources, or based on a combination thereof.

The output can be a data representation of patent coverage, summarizing how the patent claims relate to real-world products, as illustrated in the Examples. The output is not limited to the format shown in the Examples, and may be a structured legal report, semantic similarity score card, or a visualization of patent-product relationship graph. The exact format may vary depending on user preferences and the interface limitations. Confidence in the mapping can be quantified and verified using back-testing methods, such as assessing retrieval consistency and model uncertainty. By clearly defining the structure of the scope representation, the mapping process, and the final output format, the claim can be refined to better describe how LLMs and RAG contribute to enhanced patent analysis.

Herein, patent coverage refers to the extent and scope of legal protection granted by a patent. It defines what aspects of an invention are protected, specifying the boundaries within which others are prohibited from making, using, selling, or distributing the patented invention without permission. Patent coverage is determined by the claims of a patent, which describe the novel and inventive features of the invention in precise legal and technical terms.

The breadth of patent coverage depends on how the claims are written and understood contextually. Broad claims can provide wider protection but may be more vulnerable to invalidation, while narrow claims offer more precise protection but may be easier to design around. Patent coverage can also be influenced by jurisdiction, as patents are territorial rights, and by prior art, which defines the novelty of the claimed invention.

Claim elements refer to the individual components, features, or steps that make up a patent claim, and may serve as a limitation on the claim scope. Each claim element defines a specific part of the invention and is used to distinguish it from prior art. In a patent, claims are typically divided into multiple elements that collectively describe the scope of the invention.

For example, in a method claim, each claim element could represent a distinct step or action that needs to be performed to achieve the claimed invention. In an apparatus claim, claim elements might represent the individual components or parts of the device, such as a housing, a processor, or a sensor. The combination and interrelationship of these claim elements define the boundaries of the patent and determine what is protected under the claim.

Collection of patent data (or patent data) refers to a comprehensive set of information gathered from various patent-related documents, including issued patents, pending patent applications, and associated legal documents. This collection may encompass patent claims, descriptions, drawings, additional materials such as examination reports (i.e., USPTO Office Action, EPO Communication, International Search Report and Written Opinion from the International Search Authority), search reports, and legal opinions. Examination reports detail the findings of patent examiners, including any objections or rejections related to the patent application. Search reports identify prior art that may affect the novelty and non-obviousness of the claimed invention. Legal opinions provide expert analysis or assessments on the patent scope, validity, or infringement potential.

Computational model refers to a computational system, algorithm, or machine-learning-based model designed to process input data and perform a specific task. The computational model may comprise one or more individual or sub-computational model(s). These models may be trained on a collection of patent data and are responsible for interpreting a patent document, which involves extracting claim elements, identifying legal concepts, and analyzing technical details relevant to the patent. The computational model(s) could take various forms, such as one or more LLMs trained on patent texts to understand and generate structured outputs, a Natural Language Processing (NLP) model for text parsing and semantic analysis, or a Knowledge Graph-based system that organizes and connects patent information. Additionally, rule-based or AI-enhanced models (i.e., RAG) can be used for claim parsing, entity recognition, or legal term identification, and can be integrated via LLMs to form a custom model.

For example, LLMs can analyze complex patent language, identify semantic relationships, and generate structured outputs, such as claim breakdowns or summaries. When integrated with RAG, the interpretation process is further refined by retrieving relevant external knowledge, including prior art references, legal precedents, or technical literature, to provide richer contextual insights. This approach enables a more precise and comprehensive understanding of patent documents, enhancing downstream processes such as scope representation, claim mapping, and infringement analysis. The computational model may leverage RAG to dynamically retrieve pertinent prior art, case law, or legal frameworks, improving the accuracy of patent interpretation. Additionally, it can process diverse data types, including textual content, structured databases, and multimodal inputs such as images, chemical structures in machine-readable format (i.e., SMILES), or a combination thereof, ensuring a robust and adaptable analysis framework.

For example, at patent interpretation stage, the LLM could be configured with transformer layers, 8 attention heads per layer, and a hidden layer size of 768. It might use a learning rate of 1×10⁻⁴ with the Adam optimizer (β₁=0.9, β₂=0.999) and apply gradient clipping at a norm of 1.0. Tokenization may be performed using Byte-Pair Encoding (BPE) with a vocabulary of 30,000 tokens. Entity extraction could be executed using a transformer-based Named Entity Recognition (NER) algorithm that identifies technical terms and legal entities within the patent text. In addition, vector embeddings might be generated using a fine-tuned BERT model that produces 300-dimensional embeddings, and similarity scoring could be conducted via cosine similarity, with a threshold set at 0.85 to group semantically similar claim elements into a structured claim chart or graph.

It is understood that same computational model can be used throughout, when using the same computational model for both interpreting patent documents and mapping scope representations to products or services, however, the overall system must be designed to accommodate these distinct tasks. One effective approach is to implement a multi-stage processing pipeline. The first stage focuses on patent interpretation, where the model extracts key claim elements and generates a structured representation of the claims, such as vector embeddings or claim graphs. The second stage generates scope representations by structuring the extracted claim elements into standardized formats, such as claim charts. The third stage involves the mapping process, where the same computational model, with potentially fine-tuned layers or weights, maps the structured scope representations to known product or service data. The final stage ensures that the results are ranked based on similarity measures and contextual relevance, facilitating meaningful product or service matches with the patent claims. It is understood that the stages described herein may be optional and may be combined with or more other stages described herein, the order of which may be rearranged to serve any specific purpose described herein.

Further, adaptive model configurations are essential for seamlessly transitioning between interpreting and mapping tasks. One approach is multi-task learning (MTL), where the model is trained with objectives for both patent interpretation and product mapping. This allows the model to optimize task-specific parameters while maintaining shared knowledge across tasks. Further, dynamic attention mechanisms can enable the model to focus on legal language patterns for interpretation and technical or product attributes for mapping, depending on the task at hand. Task-specific fine-tuning can also be employed, where a base LLM is pre-trained on legal data for interpreting patents and fine-tuned on product and service data for mapping, ensuring the model is well-equipped to handle both stages. By leveraging shared embedding spaces and task-specific feature engineering, the model can effectively perform both tasks, providing efficient and accurate patent coverage analysis, which culminates in a refined scope representation of the patent claims.

Scope representation refers to a structured data representation that defines the boundaries and technical coverage of a patent claim. It is generated based on the interpretation of the patent document and serves as a formalized model of what the patent protects. This representation may include key claim elements, such as the components, method step, or system modules described in the patent, along with their relationships and dependencies. By structuring the claim information in this way, the scope representation enables further analysis, such as determining overlaps with existing patents, assessing infringement risks, or mapping claims to real-world products and services.

The process of generating a scope representation may involve analyzing the patent document to extract essential claim details and structuring them into a machine-readable format. This can involve breaking down independent and dependent claims, identifying variations in claim language, and linking technical features to specific limitations in the claims. Computational models, such as LLMs and RAG, can assist in refining this representation by retrieving relevant legal precedents, technical references, or similar claims. The structured output can then be used to compare against other patents, technical documents, or product specifications to determine the extent of the patent coverage and the interpretation derived therefrom.

Interpretation refers to the process of analyzing a patent document to extract meaningful information, including its claims, technical disclosures, and legal context. It involves understanding the language, structure, and intent of the patent text to determine the scope of protection it provides. Interpretation can include identifying the key components of an invention, distinguishing between independent and dependent claims, recognizing terminology variations, and assessing legal nuances such as claim dependencies and potential ambiguities, including claim elements. Claim elements are the fundamental components that define the boundaries of a patent claim. Each element represents a specific feature, function, or step that contributes to the overall invention. In a device or system claim, elements describe structural components and their relationships, while in a method claim, they outline the sequence of actions or processes required to achieve a particular result or advantage therefrom. It is therefore understood that accurate interpretation of patent claims by the computational models described herein enables mapping of claim elements, as such the interpretation may be further trained through the usage of examination report.

During patent examination, the examiner cites prior art references and specifies whether they teach or disclose certain claim elements. Teaching documents describe how a claimed feature is implemented, while disclosure documents mention or describe the feature without explaining its implementation in detail. The examination report May also provide negative examples, where it clarifies that certain references do not teach or disclose specific claim aspects. The computational model leverages this structured data by: Extracting Claim Interpretations-analyzing the examiner's reasoning regarding how prior art relates to the claims, distinguishing between teachings, disclosures, and negative examples; Learning from Examination Reports-Incorporating annotated examination reports as training data to recognize linguistic patterns, citations, and logical structures used in claim interpretation; Refining Patent Coverage Assessment-Using the learned interpretation to determine the scope of patent claims in relation to real-world products, services, or competing patents. By integrating these insights, the trained model can provide more accurate claim interpretations, identify relevant prior art for invalidity searches, and improve claim-to-product mapping, ultimately enhancing the efficiency of patent coverage analysis.

Teaching and disclosure documents herein refer to prior art references cited in an examination report to interpret claim scope and assess patentability. Teaching documents explicitly describe how certain claim elements are implemented, as stated by the examiner (e.g., “Reference A teaches X, Y, and Z”), providing a structured explanation of the claimed features. In contrast, disclosure documents mention or describe these elements without necessarily explaining their implementation, indicating a broader or indirect reference to the claimed invention (e.g., “Reference A discloses X, Y, and Z in paragraph P”). Additionally, examination reports often include negative examples, where an examiner clarifies that certain prior art references do not teach or disclose specific claim features, highlighting gaps or distinctions in prior art interpretation. These teaching, disclosure, and negative examples provide valuable insights for claim interpretation, forming a structured dataset that a computational model can leverage. By training on such data, a language model can learn to distinguish between explicit and implicit disclosures, assess how prior art references impact claim scope, and refine its understanding of common claim rejections and distinctions. This enables a more precise interpretation of patent coverage, facilitating enhanced prior art analysis and claim mapping to relevant products and services.

Product refers to any tangible item or physical object that is created, manufactured, or developed to meet a particular need or want in the market. Products are designed for sale or consumption and can be materials, machinery, equipment, devices, or other physical goods that serve a specific function. A product is often the end result or item that is protected by the claims of the patent, especially if the patent relates to the method, design, or technology used in its creation.

Service refers to an intangible offering that involves the performance of tasks, actions, or activities to fulfill a particular need or provide value to a customer. Unlike products, services are not physical objects but are instead based on expertise, skills, or labor provided to customers. In the context of patents, services may be subject to patent protection if they involve specific methods, processes, or technologies that are novel and non-obvious. For example, a service might involve a unique process or a method of delivering a service that is covered by a patent, such as a novel approach to delivering healthcare, logistics, or technology-based services.

Product or service information refers to detailed data and descriptions about a tangible or intangible offering that is provided in a market. For a product, this includes specifications, features, functionality, design, usage instructions, and any other attributes that describe the physical or digital item. It can also cover manufacturing processes, material composition, performance characteristics, and safety information. For a service, product or service information includes details about the service process, such as specific steps needed to solve a problem for customers.

Corpus of documents refers to a collection of written texts or documents that are used for analysis, research, or processing. The documents in the corpus can vary in type and content, such as academic papers, books, articles, legal texts, patent documents, or other relevant written materials. Corpus may be used to train algorithms, such as language models or search engines, enabling them to understand, generate, or process language effectively. The corpus can be domain-specific (e.g., a collection of patent documents, legal cases, or technical papers) or general (covering a wide range of topics). As described herein, one goal is to use the corpus to derive meaningful insights, perform analysis, or enhance model performance based on the linguistic patterns and knowledge contained within the documents.

These documents may comprise relevant texts or records that provide valuable information about patents, products, services, and their associated technologies. This corpus can also include patent documents, technical papers, product specifications, legal filings, examination reports, search reports, and legal opinions. For example, corpus may contain patent documents that describe the technology or methods used in a particular product or service. Additionally, the corpus may include data on products and services that use specific patented patent pending technologies. The corpus of documents may be received in certain data structure or format.

Data structure refers to an organization of data in a computer to enable efficient access, modification, and processing. It provides a systematic approach for handling data in various forms, making it easier to store, retrieve, and manipulate information for different applications. Data structures can vary in complexity and can be classified into simple types like arrays and lists, or more complex types such as trees, graphs, and hash tables. Each type is designed to optimize specific operations like searching, inserting, deleting, or updating data. The choice of data structure is influenced by the needs of the task, including the amount of data, the operations to be performed, and the performance requirements.

Claim format refers to a structure and organization in which patent claims are written and presented. It outlines the way in which the various elements of a claim—such as the preamble, transition phrases, and limitations/elements/features—are arranged to define the scope of the invention and its protection.

Data Structure associated or associating with a claim format refers to the organization of data in a way that represents the structure of a patent claim. This data structure organizes and stores the components and relationships of the claim elements in a machine-readable format. It may involve the representation of claim language, dependencies between independent and dependent claims, and the inclusion of specific limitations or features defined within the claim. The data structure ensures that the patent claims are stored in a consistent, accessible format, which can then be used for analysis, comparison, or mapping against other patents, products, or services. This structure may include fields for each claim element, relationships between claim limitations, and references to related claims or legal contexts.

One aspect is a system/method/process for determining patent coverage by interpreting patent documents using computational models trained on a collection of patent data. The interpretation generates a scope representation, which includes claim elements from the patent, and maps these representations to products or services using a second computational model. The mapping is supported by data structures related to claim formats and trained with product/service data. The method may further aggregate and consolidate mappings across multiple patent documents, offering a comprehensive data representation of patent coverage.

The method/process may comprise a step for interpreting a patent document using a computational model that has been trained on a large collection of patent data. The computational model can be configured to analyze the patent document and identify elements, including the specific language of claims and any technical details. The purpose of this interpretation is to break down the patent into a structured form, such as identifying the various claim elements that make up the scope of the patent. These claim elements are the specific features or inventions described in the patent, which are essential for determining the scope of protection that the patent provides.

For example, in the patent interpretation stage, the computational may receive input could either be the raw text of a patent claim such as “A method for producing a pharmaceutical composition comprising a chemotherapeutic agent and a stabilizer.” The output of this stage would be a structured data format, for example, a JSON object containing extracted claim elements like {“invention”: “pharmaceutical composition”, “components”: [“chemotherapeutic agent”, “stabilizer”], “method”: “production method”}. In the Scope Representation Generation stage, the input is the structured output from the interpretation stage, which is then organized into a claim chart—a graph or vector representation where each node represents a claim element and edges denote relationships. The output here might be a hierarchical graph data structure that clearly maps these relationships. Finally, in the Product or Service Mapping stage, the input is the refined scope representation, which is then mapped against product descriptions from an external dataset (e.g., a product specification stating “chemotherapy formulation with liposomal encapsulation”). The output is a mapping result that includes a similarity score and classification label indicating the level of patent coverage, such as {“product”: “Chemotherapy Formulation X”, “similarityScore”: 0.92, “coverageStatus”: “highly relevant”}.

Once the patent document has been interpreted or otherwise understood by the computational model, the next step is to generate a scope representation, which includes one or more claim elements corresponding to the patent document. The scope representation is a summary or breakdown of the patent claims, which helps in understanding the areas that the patent covers. This representation is then mapped to a product or service using a second computational model. This second model is trained with data about products and services in relation to the patent data, as described herein. The computational model may be used to determine whether a specific product or service is covered by the patent by comparing the claim elements in the scope representation to known products or services. This can be represented in form of a mapping, where the mapping process can involve using a data structure associated with a claim format.

For the scope representation generation stage, LLM parameter configurations can be predefined to structure the output from the Patent Interpretation stage. For example, the extracted claim elements (obtained as vector embeddings or parsed JSON objects) can be processed using a graph neural network (GNN) with 3 layers, an embedding dimension of 256, and ReLU activation functions to generate a structured scope representation. The model might also use attention mechanisms with 4 attention heads to weigh the importance of each claim element, and a dropout rate of 0.2 to prevent overfitting. The generated scope representation may be organized into a hierarchical claim chart or a vectorized data structure that preserves the dependencies between claim elements. These explicit parameters and configurations ensure that the claim elements are coherently structured into a refined representation that can later be used for mapping.

In this example, the input may be the structured output from the Patent Interpretation stage—such as a JSON file listing claim elements with their associated metadata (e.g., {“element”: “a processor”, “position”: “independent claim”, “attributes”: [“configured to . . . ” ]}). The output of this stage is a refined scope representation, for example, a hierarchical graph where nodes represent claim elements and edges represent their relationships. Alternatively, the output could be a single vector embedding (e.g., a 256-dimensional vector) that captures the overall structure and dependencies of the claim elements, suitable for similarity analysis in subsequent mapping tasks.

For the Product or Service Mapping stage, LLM configurations can be set to match the refined scope representation to corresponding products or services. In one example, a second computational model is employed that utilizes a transformer-based architecture fine-tuned on product and service data. This model may be configured with transformer layers, a hidden size of 512, and 6 attention heads. It could use cosine similarity with a threshold of 0.85 to compare the scope representation vector with product vectors generated from external databases. Additional parameters may include the use of TF-IDF weighting for textual product features and a dropout rate of 0.3 during training to improve generalization. These configurations enable precise mapping of the patent's structured representation to specific product features or service descriptions.

In this example, the input may be the refined scope representation generated in the previous stage (e.g., a 256-dimensional vector or hierarchical graph of claim elements). The model then compares this representation to a set of product/service descriptors, such as a product description in JSON format: {“product”: “Semiconductor Chip”, “features”: [“high-speed”, “low-power”, “integrated memory”]}. The output of this stage is a mapping result, which might be a ranked list of products or services accompanied by similarity scores (e.g., [{“product”: “Semiconductor Chip A”, “score”: 0.92}, {“product”: “Semiconductor Chip B”, “score”: 0.87}]). This mapping output clearly indicates the degree of relevance between the patent claim elements and the product or service features, facilitating informed decision-making regarding patent coverage.

After the mapping is complete, a data representation of the patent coverage is generated. The data representation can be displayed to the user or serve as an input to another process. The data representation would summarize the extent to which the patent claims apply to the identified product or service. It essentially shows how the patent claims overlap or relate to specific technologies or commercial offerings. Further, the method can involve generating a data embedding corresponding to the collection of patent data, which is a numerical representation that helps to identify relationships between patent documents and products/services.

If the patent document contains multiple inventions, the method also includes a step to generate separate scope representations for each invention. This allows for a more detailed analysis of the individual inventions within the document. Further, the method can be expanded to handle a plurality of patent documents. By aggregating the data representations of patent coverage for multiple documents, the method can identify overlaps between patents that cover similar products or services. The consolidated mapping from this aggregation can provide a comprehensive understanding of the patent coverage across multiple patents, which is particularly useful for managing large patent portfolios or performing prior art searches. Finally, the data representation of the patent coverage, based on the consolidated mapping, is outputted to give a clearer picture of how multiple patents intersect with products and services.

To implement the method/process described herein, a combination of hardware and software components can be utilized. For hardware, high-performance computing (HPC) systems or dedicated servers with powerful multi-core processors, substantial memory (e.g., 128 GB or more), and GPUs are necessary to efficiently run large-scale machine learning models such as LLMs and RAG. GPUs are especially for parallel processing tasks such as model training and inference, enabling faster and more scalable operations. Additionally, robust storage systems are needed to handle large volumes of patent data, including patent documents, prior art, search reports, and legal opinions, ensuring that data is readily accessible for interpretation and analysis. These storage systems must be designed for high throughput and low latency to support quick retrieval of relevant information during the patent coverage determination process. For software, specialized machine learning frameworks and libraries such as TensorFlow, PyTorch, or Hugging Face's Transformers would be employed to implement the computational models for interpreting patent documents and generating scope representations. NLP tools would be used to parse complex patent language, recognize claim elements, and map them to products or services. Additionally, software for managing and querying patent databases, such as Elasticsearch or SQL-based systems, would be used to store and retrieve the data required for model training and execution. The method may also utilized custom algorithms for mapping the scope representations to relevant products or services, ensuring that the output data accurately reflects patent coverage. These algorithms may be part of the computational model or an independent add-on.

The training data for the computational model comprises various patent-related datasets, including patent documents, prior art, legal opinions, and other intellectual property data. These datasets enable the model to process patent language, structure, and claims effectively. The training process involves using labeled patent data through a supervised learning approach, where patent documents are annotated with claim elements, claim scope, and relevant legal or technical concepts. The training data May include full-text patent documents with claims, descriptions, and legal statements, which teach the model to identify key claim elements such as “method,” “system,” or specific components in method and device claims. For example, for a method claim, claim elements may include steps such as “receiving an input . . . ,” “processing data . . . ,” or “generating an output . . . ” In a device claim, elements might describe physical components such as “a processor configured to . . . ,” “a memory unit coupled to . . . ,” or “a communication module integrated with . . . ” These elements represent distinct aspects of the invention and define the scope of protection. In addition, prior art, including historical patents, articles, and case law, is used to train the model to understand the relationships between patents and other relevant documents. Metadata on legal status, such as patent expiry, licensing agreements, and legal disputes, also aids the model in recognizing the enforceability and relevance of patents. Furthermore, product and service data, such as product specifications, technical descriptions, and industry reports, help the model map patent claims to specific products or services.

Example datasets used for training include the USPTO (or patent office database from other jurisdictions) patent collection, which offers comprehensive details on U.S. patents, including claims, descriptions, and drawings, to help the model understand patent language. Similarly, the EPO patent dataset provides valuable insight into international patent differences and similarities. Patent citation data shows how patents reference one another, allowing the model to understand their interrelations. Additionally, product databases may comprise descriptions of products and services, including technical specifications and product catalogs, which are used to train the model to map patent claims to corresponding products or services.

One aspect is a method for training a computational model, i.e., LLM, to determine patent coverage by analyzing and mapping patent claims to products or services. The method comprises the following example steps:

Collection and Preprocessing of Patent Data: The first step in the training process involves the collection of a large dataset of patent documents, including granted patents, published patent applications, and associated prior art citations. The dataset is curated to include various patent types, including pharmaceutical, mechanical, and electrical patents. Each patent document contains a set of claims, which represent the legal scope of protection afforded by the patent. These claims are accompanied by detailed specifications that describe the invention in greater detail. The collected patent data is preprocessed to standardize the format and structure. This includes tokenizing the patent text into individual claim elements, such as keywords, phrases, and specific technological terms, and creating labeled datasets that associate claim elements with their respective patent classifications (e.g., pharmaceutical, mechanical, etc.).

Incorporating External Contextual Data for Patent Relevance: In addition to patent documents, the method incorporates external contextual data to enhance the LLM's ability to map patent claims to relevant products and services. This external data may include product descriptions, clinical trial data, market information, and competitor analysis. The external data is obtained from publicly available resources, including market reports, product databases, and clinical trial databases, and is integrated into the training set.

The external data is preprocessed in a similar manner as the patent data, where relevant keywords and technological features of the products or services are extracted. These features are then labeled in a way that aligns with the claim elements extracted from the patent documents.

Training the LLM with Patent and Contextual Data: Once the patent and contextual datasets have been prepared, the LLM is trained using a supervised learning approach. The LLM is provided with input pairs consisting of patent claim elements (as the input) and the corresponding products or services (as the output). The LLM uses these input-output pairs to learn patterns and relationships between the claim elements and the associated products or services. The LLM is trained using a variant of the transformer architecture, with attention mechanisms that allow the model to focus on relevant claim elements within the patent document. The model is trained using a loss function that minimizes the difference between predicted product-service mappings and the actual mappings in the training data. The training process is optimized using gradient descent algorithms, with hyperparameters adjusted based on model performance on a validation dataset.

Fine-Tuning the LLM with RAG: After the initial training phase, the model is fine-tuned using RAG techniques. In this phase, the model is equipped with an information retrieval system that allows it to fetch relevant external data based on the context of the patent claims. The retrieval system searches a database of external resources, such as product descriptions or industry reports, and returns documents that are most likely to enhance the contextual relevance of the claim elements. The LLM then integrates this retrieved contextual data into the patent claims, enriching the scope representation of the claims and refining the model's understanding of the relevant products or services. This process helps the model learn how to make more accurate mappings, taking into account both patent data and real-world context.

Evaluation and Optimization: After training, the model's performance is evaluated using a separate test dataset that was not used during training. The test dataset contains additional patent claim elements along with their corresponding products or services. The model's output is compared against the true mappings to assess its accuracy, precision, recall, and overall performance. The model is further optimized based on performance metrics, with adjustments made to the learning rate, batch size, and other hyperparameters to improve its ability to generalize to new, unseen patent claims. Techniques such as cross-validation and model ensembling may be employed to further enhance the model's robustness and accuracy.

Deployment for Patent Coverage Determination: Once the model has been trained and optimized, it is deployed in a system designed for patent coverage determination. The system receives a new patent document, interprets the claims using the trained LLM, generates scope representations for the claims, and maps these representations to relevant products or services. The system outputs a data representation of the patent coverage, which is used for tasks such as prior art searches, infringement assessments, and portfolio management.

One aspect is a multi-stage processing pipeline with delineated operational phases. In the first stage—Patent Interpretation—the system employs LLM trained on a comprehensive patent dataset to extract claim elements from a patent document using defined tokenization, parsing, and entity recognition algorithms. The output of this stage is a structured representation of the claim elements. In the second stage—Scope Representation Generation—the extracted claim elements are organized into a standardized data format (such as vector embeddings or claim charts) that explicitly captures the relationships and dependencies among the elements. Transitioning to the third stage—Product or Service Mapping—the system applies a second model (or a distinct configuration of the same model) trained on product and service data. This model maps the standardized scope representation to real-world products or services using predefined similarity metrics (e.g., cosine similarity, TF-IDF, or neural network-based measures). Each stage is governed by explicit thresholds and state indicators that ensure the output from one stage is validated and formatted appropriately before being passed to the next. These detailed configurations and clearly defined transitions between stages provide a replicable roadmap that addresses enablement concerns, ensuring that a person skilled in the art can implement the invention without undue experimentation.

For example, the multi-stage processing pipeline may be configured based on the delineated operational phases and retain parameters for each stage. In the initial Patent Interpretation stage, a LLM based on a transformer architecture is employed, which is pre-trained on a corpus of patent documents (e.g., USPTO and EPO datasets) and fine-tuned with parameters such as 12 transformer layers, 8 attention heads, and a hidden size of 768. This model uses an Adam optimizer with an initial learning rate of 1×10⁻⁴ and gradient clipping set to 1.0, enabling it to tokenize and parse patent text to extract claim elements via defined entity recognition algorithms, outputting structured vector embeddings. These embeddings are then standardized into a scope representation—formatted as a claim chart or graph—by organizing claim elements and their interdependencies using task-specific feature engineering. In the subsequent stage, RAG module is integrated into the pipeline, configured with a dense retrieval mechanism that dynamically fetches external contextual data from product and service databases. This RAG module uses a cosine similarity threshold of 0.8 to retrieve the top 10 relevant documents, whose data is then concatenated with the scope representation to refine its contextual accuracy. Finally, in the Product or Service Mapping stage, either a second computational model or a distinct configuration of the original LLM, fine-tuned on product and service datasets, is used to map the refined scope representation to real-world products or services. This mapping employs similarity metrics-such as cosine similarity and TF-IDF—with additional weighting factors based on claim breadth, examiner citation patterns, and historical enforcement data, ensuring a robust ranking of product relevance. Cross-validation and model ensembling techniques are applied throughout the pipeline to optimize performance and ensure replicability.

In another example, the computational model may be trained specifically to map scope representations to products or services, and would be trained with a dataset of products and services, including their technical descriptions and use cases. This data could come from public product databases (e.g., global product catalogs, e-commerce platforms, or industry-specific product registries). The model would learn to match patent claim elements with relevant products or services based on their descriptions, features, or technical applications. For example, the model might learn to map a claim related to a “method for manufacturing a semiconductor device” to products like semiconductor chips or specific manufacturing equipment.

Once the training data is prepared, machine learning algorithms such as supervised learning, reinforcement learning, or unsupervised learning techniques can be used to train the model. These algorithms help the model learn patterns and relationships from the data, allowing it to interpret patent claims, generate scope representations, and match them to relevant products or services. The more comprehensive and diverse the training data, the more accurate and reliable the model's output will be.

In another example, scope representation can be generated based on the interpretation of a patent document involves several steps, for example, the patent document, particularly its claims, is interpreted using computational techniques such as NLP or other analysis methods. This interpretation helps in identifying the key components, features, and relationships described in the claims. An exemplary model or system may be used to parse the language of the claims to distinguish the specific elements that define the invention, such as structural components, actions, or steps. Once the key elements are identified, a scope representation is created by mapping these elements into a structured format. This format outlines the various claim elements and how they relate to one another, often providing a clearer understanding of the boundaries and scope of the patent. The representation may also include details about how each element fits within the overall context of the invention, thereby capturing the essence of the claim in a manner that can be analyzed further for tasks such as patent comparison, infringement analysis, or patent prosecution.

In another example, the computational model may be one or more LLMs. Said one or more LLMS are configured to generate a scope representation by leveraging their ability to process, interpret, and structure patent claims based on learned linguistic and technical patterns. The process begins with the LLM analyzing the text of a patent document, particularly its claims, description, and any relevant legal context. The model identifies key elements within the claims, such as specific components, methods, or relationships between them.

Next, the LLM breaks down complex claim language into structured representations by recognizing dependencies, functional groupings, and semantic meanings. This involves parsing the claim text, standardizing terminology, and resolving ambiguities to ensure consistency. When integrated with RAG, the LLM enhances its interpretation by retrieving relevant prior art, technical dictionaries, and legal definitions, ensuring that the generated scope representation aligns with industry standards and established interpretations.

Once the claim elements are identified, the LLM organizes them into a structured data format, such as a hierarchical representation, a semantic embedding, or a graph-based structure. This structured output serves as the scope representation, which can then be used for mapping to products or services, infringement analysis, and prior art comparison. The LLM may also generate multiple scope representations to account for different possible interpretations, improving the robustness and flexibility of downstream patent analysis applications.

LLMs may be part of or separate the computational models, or the framework thereof, which include but are not limited to, machine learning models, such as deep neural networks, recurrent neural networks, transformers, and other architectures, trained to learn a probability distribution over sequences of words or tokens. LMs, whether large or small, and other machine learning or statistical models are trained to produce text that mimics the structure of the text presented in their training data. LMs can be used, for example, to simulate human-like responses to questions or requests for information.

Hardware for LLMs and/or agents training and inference may comprise one or more processors (e.g., GPUs or TPUs) or other hardware (logic) components designed to handle the needed computations. The LLMs and/or agents also require suitable amounts of memory to process data sets associated with the user's health, environment, location, etc., as well as the processing by computational models such as neural networks. Specialized hardware may be used to accelerate training and inference, offering flexibility but potentially at reduced speeds. The hardware would also support rapid data processing and system updates, enabling real-time adjustments and maintaining performance. The LMs and/or agents may be trained using multimodal data on said one or more processors as described herein. The training involves a compilation of the multimodal data in formats such as text, images, audio, and video.

For example, the LLM hardware may be a high-performance computing cluster comprising four nodes, each equipped with dual Intel Xeon Gold processors, 128 GB of RAM, and four NVIDIA Tesla V100 GPUs. The system might run Ubuntu Linux 20.04 with CUDA 11 and utilize software frameworks such as PyTorch 1.9 and TensorFlow 2.5, along with the HuggingFace Transformers library for training the LLM. For data storage, a 10 TB NVMe SSD array could be employed to ensure high throughput and low latency. Additionally, the retrieval-augmented generation component may rely on dense retrieval frameworks like FAISS or Elasticsearch to fetch external documents in real-time. Including these hardware and software specifics provides a clear, replicable blueprint that enables a person skilled in the art to implement the invention efficiently.

Another aspect is a system/method/process for determining patent coverage by employing a series of computational steps that begin with interpreting a patent document. First, a computational model—often an LLM trained on extensive patent data—analyzes the patent document to extract its key claim elements or features. From this analysis, the system generates a structured scope representation that outlines the specific technical and legal boundaries of the patent claims.

A second or the same computational model may be used, trained with product and service data, to map the generated scope representation to corresponding products or services. This mapping process involves performing a search based on the scope representation and retrieving a corpus of documents—such as product specifications, technical descriptions, or regulatory filings—that are contextually relevant. The model then classifies the products or services based on their alignment with the patent scope, using a data structure associated with a claim format to standardize the information.

Further, a feedback mechanism may be integrated, whereby the updating the second computational model with the newly retrieved corpus, which continuously refines its understanding and improves subsequent mappings. In cases where the patent document covers multiple inventions, the process generates separate scope representations for each invention. The mappings may be aggregated and consolidated across multiple patent documents, outputting a comprehensive data representation of the patent coverage. It is understood that the output described herein would enable more accurate patent analysis and supports decision-making in areas such as patent prosecution, infringement analysis, and portfolio management.

Another aspect is a system/method/process for determining patent coverage by further integrating the interpretation and mapping functions into a more cohesive and unified model. One refinement is that the same computational model that interprets the patent document can also handle the mapping tasks, meaning that instead of having two separate models, one model is used throughout the process. This unified model not only extracts the claim elements from the patent document but also generates a specialized data structure based on a defined claim format. For example, this data structure might be a vector representation, claim chart, or graph that captures the structural and functional aspects of each patent claim in a standardized way.

When a unified computational model is used for both patent interpretation and product mapping, for example, the disclosure would delineate how the model transitions between these tasks. For example, the unified model can be structured as a multi-stage pipeline with explicit subroutines: one stage (e.g., an “interpretPatent( )” function) processes the raw patent text to extract claim elements and generate a structured scope representation, and a subsequent stage (e.g., a “mapToProduct( )” function) takes that representation and applies mapping algorithms to match against product or service data. Each stage may have its own set of hyperparameters and loss functions—for instance, using a learning rate of 1×10⁻⁴ for interpretation and a modified learning rate for mapping- and intermediate outputs can be stored in standardized formats (such as JSON or vector embeddings) to ensure proper handoff between stages.

Once the data structure is generated, the method then consolidates these structures under one or more classifications. This classification step organizes the claim elements into groups that reflect similar features or inventions, ensuring that each scope representation accurately corresponds to a particular invention or subset of claims. By grouping the data structures according to their classifications, the system can produce a more refined and context-aware scope representation that clearly delineates the boundaries of each invention covered by the patent document.

The refined scope representation is then used to drive a more targeted search for relevant products or services. The search is prioritized based on how closely the structured scope representation aligns with contextual information from external sources, such as product databases, technical literature, or other disclosures related to the patent document. In this way, the system ensures that the mapping process not only identifies potential products or services but also evaluates their relevance in a meaningful, context-dependent manner.

Further, by updating the computational model with the newly retrieved corpus of documents—which can include various related disclosures, such as technical papers, legal opinions, or additional patent documents—the system continuously refines its understanding and mapping accuracy over time. This iterative process allows the method to adapt to new information, ensuring that the scope representation and the subsequent product or service mapping remain current and relevant. Overall, these additional steps enhance the robustness, precision, and scalability of the patent coverage determination method by deeply integrating data structuring, classification, and context-aware search functions.

It is understood that the multi-stage processing pipeline described herein is not limited to the integration of LLMs with RAG. There is an apparent demarcation of processing stages—comprising patent interpretation, scope representation generation, and product or service mapping—each with defined parameters such as transformer layer counts, attention heads, and vector embedding dimensions. This explicit configuration not only ensures reproducibility and effective enablement for a person skilled in the art but also demonstrates technical benefits, including real-time contextual data integration, enhanced accuracy in claim parsing, and robust mapping of patent claims to relevant products or services.

Another aspect is a system/method/process for determining patent coverage by refining the mapping between patent claims and the corresponding product or service. This may be done by processing the extracted claim elements using various computational techniques. In this stage, the claim elements within the scope representation may be processed using methods such as rule-based logic, statistical modeling, machine learning, or other artificial intelligence-based approaches. The goal is to determine a similarity measure between these claim elements and the features of the mapped product or service. This similarity may also be computed through techniques such as keyword matching, vector embeddings, semantic similarity analysis, or context-aware inference, which quantify how closely the patent claims align with the characteristics of the product or service.

Once the similarity measure is established, the method adjusts the contextual relevance of the claim elements by applying predefined weighting factors. These weighting factors might consider aspects such as claim breadth, prior legal determinations, examiner citation patterns, or historical enforcement data, effectively prioritizing certain claim elements over others based on their legal and technical significance. Following this, the computed relevance scores are normalized to facilitate a standardized ranking of products or services with respect to the patent document. In another embodiment, the method explicitly uses metrics like cosine similarity, TF-IDF, or neural network embedding-based similarity measures to determine the initial similarity score, applies weighting factors based on criteria such as semantic relevance and historical litigation outcomes, and then normalizes these scores, ensuring an effective and consistent ranking system for assessing patent coverage.

One aspect is a system/method/process for determining patent coverage that integrates patent interpretation, product mapping, and contextual data retrieval into a unified process. It may begin by interpreting a patent document using at least one first computational model trained with a collection of patent data, which extracts key claim elements from the document. These claim elements are then organized into a structured scope representation corresponding to the patent document. The scope representation is generated by producing a data structure—such as a vector representation or claim chart—based on one or more patent claims, where each invention scope corresponds to a standardized claim format.

Mapping of the scope representation to a product or service may be accomplished by using at least one second computational model trained with data on products and services in relation to the patent data. The mapping involves performing a search for the product or service based on the scope representation and retrieving a corpus of documents that are contextually relevant, with the search prioritized based on the similarity between the claim elements and product or service features. The mapping is further refined by processing the claim elements using computational techniques (such as rule-based logic, statistical modeling, machine learning, or AI-based processing) to determine a similarity measure—using techniques like cosine similarity, TF-IDF, or neural network embedding-based similarity metrics—and adjusting the similarity score based on predefined weighting factors (e.g., claim breadth, prior legal determinations, examiner citation patterns, or historical enforcement data) before normalizing the scores to rank products or services with respect to the patent document.

It is understood that in one or more aspects described herein, such that computational models for interpreting patent documents and mapping scope representations to products or services may be unified into a single, versatile system. This unified model is configured to operate in distinct processing stages or modes, where it initially interprets the patent document to extract and structure key claim elements, and then seamlessly transitions to mapping these structured representations against relevant products or services. By employing a unified architecture, the system can leverage shared underlying data representations and learning frameworks, ensuring consistency across both tasks while reducing complexity and resource requirements. This approach not only streamlines the workflow but also facilitates continuous refinement, as updates in one stage can dynamically improve performance in the other, ultimately leading to more accurate and integrated patent coverage analysis.

The computational models may be integrated with contextual data using RAG with respect to the interpretation, and/or the mapping processes. For example, after generating the scope representation, the method further comprises retrieving relevant external information (e.g., prior art, legal opinions, technical literature) via RAG and incorporating this information into the scope representation to refine the contextual relevance of each claim element. In another example, during the search for products or services, the second computational model uses RAG to dynamically update and expand the corpus of documents associated with the product or service, thereby ensuring that the mapping remains accurate and current.

Moreover, data representation of patent coverage across multiple patent documents may be aggregated, and simultaneously or subsequently consolidating the mapping based on overlapping scope representations for the same product or service. The consolidated mapping is then output as a comprehensive data representation of the patent coverage.

One aspect is a system/method/process for determining patent coverage that utilizes multiple computational models and modules that work together to analyze a patent document and assess its scope concerning relevant products and services. One model is trained on a collection of patent data and is responsible for interpreting a patent document to extract its claim elements. These extracted elements serve as the foundation for generating a structured scope representation, which provides a standardized format for defining the technical coverage of the patent. The scope representation module processes these extracted claim elements and ensures they are formatted consistently, facilitating accurate mapping and comparison. The second computational model, which is trained with data on products and services in relation to the collection of patent data, is responsible for mapping the scope representation to a product or service, a process that involves generating at least one data structure associated with a claim format. The mapping ensures that the structured patent claims are aligned with corresponding technical specifications, features, or functionalities of real-world products and services. By leveraging this structured mapping, the system can assess patent coverage across different industries and applications.

RAG may be integrated into the first computational model to dynamically retrieve relevant contextual information based on the content of the patent document. The RAG process ensures that the first computational model is not limited to static pre-trained knowledge but can fetch real-time patent data, legal insights, and technical references from external sources. This retrieved information is then integrated into the scope representation, refining the contextual relevance of the extracted claim elements and improving the precision of patent-to-product mapping.

During the search and mapping processes, the updated scope representation is applied to ensure a more accurate and context-aware determination of patent coverage. By leveraging the refined scope representation, the system can effectively identify relevant products or services, determine their similarity to patent claims, and output a data representation of the patent coverage. This structured output provides valuable insights into potential overlaps, prior art relevance, and patent enforcement considerations. The integration of machine learning techniques, structured data representation, and retrieval-based augmentation enables a more efficient and scalable approach to patent analysis, addressing the limitations of traditional manual examination methods.

It is understood that, in one or more aspects described herein, the use of RAG enhances precision in identifying significantly, whether a product or service falls within the scope of a given patent claim by leveraging real-time retrieval of relevant data instead of depending solely on pre-trained models.

One aspect is a method or computer-implemented method for (of) determining patent coverage, comprising: interpreting a patent document using at least one first computational model trained with a collection of patent data; generating at least one scope representation based on the interpretation, wherein said at least one scope representation comprises one or more claim elements corresponding to the patent document; mapping said least one scope representation to a product or service using at least one second computational model trained with data on products and services in relation to the collection of patent data, wherein the mapping comprises at least one data structure associated with a claim format; and outputting a data representation of the patent coverage for the patent document based on the mapping.

One aspect is a system for determining patent coverage, wherein the system comprises one or more modules, comprising: at least one first computational model trained with a collection of patent data, wherein said at least one first computational model is configured to interpret a patent document and extract one or more claim elements; wherein said one or more modules are configured to generate at least one scope representation based on the interpretation, wherein said at least one scope representation comprises said one or more claim elements corresponding to the patent document; at least one second computational model trained with data on products and services in relation to the collection of patent data, wherein said at least one second computational model is configured to map said at least one scope representation to a product or service, said mapping comprising at least one data structure associated with a claim format; and wherein said one or more modules are further configured to output a data representation of the patent coverage for the patent document based on the mapping.

One aspect is an apparatus that manages data, comprising: a processor; and a memory, coupled to the processor, the memory comprising instructions that, when executed by the processor, cause the apparatus to perform the method steps according to one or more aspects and/or options described herein.

One aspect is a non-transitory machine-readable medium comprising instructions that, when executed by a machine, cause the machine to perform operations according to one or more aspects and/or options described herein.

One aspect is a method for (of) training a computational model to interpret patent coverage of a patent document, comprising: receiving training data comprising one or more of patent documents, prior art references, publications, opinions, examination reports, and product or service catalogs; processing the training data based on one or more criteria associated by using one or more techniques of tokenization, entity recognition, and vector embedding generation; training the computational model using the processed training data, wherein the computational model is configured to distinguish claim elements, legal concepts, and technical descriptions, and generate a structured mapping between them; and generating a trained computational model configured to interpret the patent coverage of the patent document in accordance with claims one or more aspect and/or options described herein.

As an option, further comprising: generating a data embedding corresponding to the collection of patent data based on the interpretation. As an option, further comprising receiving a patent document comprising one or more inventions; and generating said at least one scope representation corresponding to each invention in the patent document. As an option, further comprising: aggregating the data representation of the patent coverage for a plurality of patent documents; consolidating said mapping based on overlap of said least one scope representation for the same product or service; and outputting a data representation of the patent coverage based on the consolidated mapping for the plurality of patent documents. As an option, further comprising: performing a search for the product or service based on said at least one scope representation using said at least one second computational model; and identifying a corpus of documents associated with the product or service according to the search based on the contextual relevance of each document in the corpus to said at least one scope representation. As an option, wherein said at least one second computational model is configured to encode the product or service information based on the claim format; and/or updating said at least one second computational model with the corpus of documents. As an option, further comprising: obtaining a corpus of documents based on said at least one second computational model; identifying at least one product or service 6 from a predetermined list of products or services based on an analysis of the corpus of documents, wherein the said at least one product or service is contextually relevant to said at least one scope representation based on an assessment made by at least one second computational model of the corpus of documents and said at least one scope representation in accordance with the analysis; and classifying said at least one product or service based on the assessment; and identifying the product or service based on the classification. As an option, further comprising: analyzing the corpus of documents according to the predetermined list of products or services; and/or assessing the patent coverage of the patent document based on the mapping. As an option, wherein said at least one first computational model comprises one or more language models configured to conduct contextual searches from one or more sources; and/or wherein said at least one first computational model comprises said at least one second computational model. As an option, wherein said obtaining at least one scope representation, further comprising: generating at least one data structure associated with a claim format based on one or more patent claims in the patent document, wherein the data structure comprises one or more vector representations of one or more patent claims; and obtaining said at least one scope representation based on said at least one data structure, wherein each invention scope corresponds to a claim format. As an option, further comprising: consolidating said at least one data structure under one or more classifications; and obtaining said at least one scope representation based on the consolidating said at least one data structure in relation to said one or more classifications. As an option, wherein the claim format comprises a claim chart or graph.

As an option, wherein the search is based on one or more patent claims in the patent document, prioritized based on relevance between said at least one scope representation associated with said one or more patent claims and contextual information from one or more sources. As an option, wherein the corpus of documents comprises one or more disclosures associated related to the patent document. As an option, further comprising: processing said one or more claim elements in said at least one scope representation of the mapped product or service using at least one computational technique with respect said at last one first computational model, wherein the computational technique comprises one or more of rule-based logic, statistical modeling, machine learning, or artificial intelligence-based processing; and determining a similarity measure between said one or more claim elements and the mapped product or service based on at least one of keyword matching, vector embeddings, semantic similarity analysis, context-aware inference, or a combination thereof; adjusting contextual relevance based on at least one predefined weighting factor, wherein said at least one weighting factor is based on at least one of claim breadth, prior legal determinations, examiner citation patterns, historical enforcement data, or a combination thereof; and normalizing the contextual relevance to facilitate ranking of products or services with respect to the mapping of the patent document. As an option, further comprising: determining a similarity measure between said one or more claim elements in said at least one scope representation of the mapped product or service using at least one of cosine similarity, term frequency-inverse document frequency (TF-IDF), a neural network embedding-based similarity metric, or a combination thereof; applying at least one weighting factor to prioritize said one or more claim elements based on predefined criteria, wherein the predefined criteria comprise at least one of semantic relevance, historical litigation outcomes, examiner citations, or a combination thereof; and normalizing the computed relevance scores to facilitate ranking of products or services with respect to the patent document. As an option, further comprising: receiving the collection patent data using retrieval-augmented generation, wherein the retrieval-augmented generation is integrated to said at least first computational model that dynamically identifies and fetches relevant contextual information based on the content of the patent document; integrating the collection patent data into said at least one scope representation to refine the contextual relevance of said one or more claim elements; and applying the updated scope representation during the mapping and search processes to enhance the accuracy and relevance of the product or service matching with respect to said at least one second computational model.

One aspect is a computing environment for implement one or more aspect described herein, the environment is not intended to suggest any limitation as to the scope of use or functionality of the technology, as the technology may be implemented in diverse general-purpose or special-purpose computing environments, whereby the environment may be configured to serve distinct operational stages—comprising patent interpretation, scope representation generation, and product or service mapping—each governed by defined parameters (e.g., transformer layer counts, attention head numbers, vector dimensions, and learning rate thresholds) and reinforced by dynamic feedback mechanisms. For example, the disclosed technology may be implemented with other computer system configurations, including hand-held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

As another option, wherein the structured mapping is represented as a semantic relationship model or vector space embedding. As another option, wherein said one or more criteria comprise patent classification and technical terminology. As another option, wherein said training the computational model comprises one or more of multi-layer attention mechanisms, transformer-based embeddings, and supervised learning with annotated patent datasets. As another option, further comprising: integrating retrieval-augmented generation to the training to enhance claim scope interpretation by retrieving relevant prior art, legal precedents, and technical references from external databases, wherein retrieved data is processed through a similarity scoring mechanism based on cosine similarity or dense vector embeddings. As another option, further comprising optimizing the model with multi-task learning to optimize both claim interpretation and claim-to-product mapping, wherein the model dynamically adjusts attention weights to focus on legal language patterns for interpretation and technical attributes for mapping. As another option, further comprising: deploying the trained computational model, wherein the trained model is configured to interpret patent claims, identify key claim elements, and determine claim scope with improved accuracy in accordance one or more aspects and/or options described herein. As another option, wherein the computational model is configured to learn based on teaching and disclosed documents cited in the examination report with respect to claim interpretation, wherein the claim interpretation learned by the computational model can be used to assess patent coverage.

An exemplary computing environment includes at least one processing unit and memory. This most basic configuration is included within a dashed line. The processing unit executes computer-executable instructions and may be a real or a virtual processor. In a multi-processing system, multiple processing units execute computer-executable instructions to increase processing power and as such, multiple processors can be running simultaneously. The memory may be volatile memory (e.g., registers, cache, RAM), non-volatile memory (e.g., ROM, EEPROM, flash memory, etc.), or some combination of the two. The memory stores software, images, and video that can, for example, implement the technologies described herein. A computing environment may have additional features. For example, one or more co-processing units or accelerators, including graphics processing units (GPUs), can be used to accelerate certain functions, including the implementation of artificial neural networks. The computing environment may also include storage, one or more input device(s), one or more output device(s), and one or more communication connection(s). An interconnection mechanism (not shown) such as a bus, a controller, or a network, interconnects the components of the computing environment. Typically, operating system software (not shown) provides an operating environment for other software executing in the computing environment and coordinates the activities of the components of the computing environment.

The storage may be removable or non-removable and includes magnetic disks, magnetic tapes or cassettes, CD-ROMs, CD-RWs, DVDs, or any other medium which can be used to store information and that can be accessed within the computing environment. The storage stores instructions for the software, image data, and annotation data, which can be used to implement technologies described herein.

The input device(s) may be a touch input device, such as a keyboard, keypad, mouse, touch screen display, pen, or trackball, a voice input device, a scanning device, or another device that provides input to the computing environment. For audio, the input device(s) may be a sound card or similar device that accepts audio input in analog or digital form, or a CD-ROM reader that provides audio samples to the computing environment. The output device(s) may be a display, printer, speaker, CD-writer, or another device that provides output from the computing environment.

The communication connection(s) enable communication over a communication medium (e.g., a connecting network) to another computing entity. The communication medium conveys information such as computer-executable instructions, compressed graphics information, video, or other data in a modulated data signal. The communication connection(s) are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

It is understood that one or more method steps described herein may be optional or additional, and these steps may be incorporated into aspects of one or more systems described herein or combined with any other steps in relation to one or more aspects, embodiments, or examples.

In the embodiments, examples, and aspects of the invention as described above such as process(es), method(s), system(s) may be implemented on and/or comprise one or more cloud platforms, one or more server(s) or computing system(s) or device(s). A server may comprise a single server or network of servers, the cloud platform may include a plurality of servers or network of servers. In some examples the functionality of the server and/or cloud platform may be provided by a network of servers distributed across a geographical area, such as a worldwide distributed network of servers, and a user may be connected to an appropriate one of the network of servers based upon a user location and the like.

The above description discusses embodiments of the invention with reference to a single user for clarity. It will be understood that in practice the system may be shared by a plurality of users, and possibly by a very large number of users simultaneously.

The embodiments described above may be configured to be semi-automatic and/or are configured to be fully automatic. In some examples a user or operator of the querying system(s)/process(es)/method(s) may manually instruct some steps of the process(es)/method(es) to be carried out.

The described embodiments of the invention a system, process(es), method(s) and/or tool for querying a graph data structure and the like according to the invention and/or as herein described may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the process/method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium or non-transitory computer-readable medium. Computer-readable media may include, for example, computer-readable storage media. Computer-readable storage media may include volatile or non-volatile, removable or non-removable media implemented in any method or technology for storage of information such as computer-readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection or coupling, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Application-specific Integrated Circuits (ASICs), Application-specific Standard Products (ASSPs), System-on-a-Chip (SoC) systems, Complex Programmable Logic Devices (CPLDs), Graphics Processing Units (GPUs), Tensor Processing Units (TPUs), and other similar specialized hardware accelerators.

A person of ordinary skill in the art may understand that, all or some steps of the methods of the foregoing embodiments may be implemented through instructions, or implemented through instructions controlling relevant hardware, and the instructions may be stored in a computer-readable storage medium and loaded and executed by a processor. The storage medium may include a read-only memory (ROM), a random access memory (RAM), a magnetic disk, an optical disc, or the like.

Although illustrated as a single system, it is to be understood that the computing device may be a distributed system. Thus, for instance, several devices May be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, IoT devices, mobile telephones, personal digital assistants and many other devices.

The term “configured to” is used in different contexts related to computer systems, hardware, or part of a computer program, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations.

When a computer program, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, described can be integrated together as a single system or be part of multiple systems.

Those skilled in the art will realise that storage devices utilised to store program instructions can be distributed across a network. For example, a remote computer may store an example of the process described as software. A local or terminal computer may access the remote computer and download a part or all the software to run the program. Alternatively, the local computer may download pieces of the software as needed or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary”, “example” or “embodiment” is intended to mean “serving as an illustration or example of something”. Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art.

What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended.

### EXAMPLES

The following examples are provided to illustrate how the present disclosure enables a person skilled in the art to implement the invention based on the technical details disclosed herein and should not be construed as accurate claim/patent data or legal conclusion with respect to patentability or infringement.

### Example 1

Patent: Capillary-Based Droplet PCR

| | Capillary-Based | |
|---|---|---|
| Claim 11 Elements | ddPCR System | Roche LightCycler II |
| Channels comprise a | Yes-Uses capillaries for | Yes-Uses capillary tubes |
| capillary | droplet generation and | for PCR, but not explicitly |
| | thermal cycling | for droplet-based reactions |
| Capillary has a circular | Likely-Most capillary tubes | Yes-Roche LightCycler |
| cross-section | used in microfluidics have a | uses circular capillary tubes |
| | circular cross-section | |
| Segmenting the sample | Yes-Utilizes immiscible | No-LightCycler does not |
| into droplets using | carrier fluid to create | employ immiscible carrier |
| continuous flow of | droplets within the capillary | fluid or droplet |
| immiscible carrier fluid | | segmentation |
| Thermal cycling of droplets | Yes-Thermal cycling | Yes-Thermal cycling |
| | occurs within the capillary | occurs in the capillary |
| | droplets | tubes, but not for droplet- |
| | | based PCR |
| Flowing droplets past a | Yes-Droplets are flowed | No-LightCycler uses bulk |
| detector by immiscible | past a detection system for | reaction monitoring, not |
| carrier fluid | fluorescence measurement | individual droplet flow |
| | | detection |

The Capillary-Based ddPCR System appears to meet all elements of claim 11, making it a highly relevant comparable product. The Roche LightCycler II shares capillary-based thermal cycling features but does not employ droplet-based processing with immiscible carrier fluid, making it only partially relevant.

### Example 2

Patent: Sustained-Release Metformin Tablet

| | | Januvia | Additional |
|---|---|---|---|
| Claim 7 Elements | Glucophage XR | (Sitagliptin) | Observations |
| Specific: | | | |
| Formulation | Yes-Glucophage | No-Januvia is | Glucophage XR |
| includes a | XR uses a | an immediate- | directly meets the |
| hydrophilic polymer | hypromellose-based | release | specific requirement |
| matrix that controls | polymer matrix that | formulation and | by using a hydrophilic |
| the drug's release | releases Metformin | does not include a | matrix. Januvia fails |
| over an extended | over 12+ hours | controlled-release | this element as it |
| period | | mechanism | lacks sustained- |
| | | | release features. |
| Measurable: | | | |
| The release profile | Yes-Glucophage | No-Immediate- | Glucophage XR |
| maintains | XR is designed to | release | clearly meets the |
| therapeutic plasma | provide sustained | formulation leads | measurable criteria by |
| levels for at least 12 | plasma | to rapid | providing therapeutic |
| hours | concentrations over | absorption and | levels for over 12 |
| | a 12-hour period | short duration of | hours. Januvia does |
| | | action | not meet this |
| | | | requirement. |
| Achievable: | | | |
| Sustained-release | Yes-The | No-Januvia | Glucophage XR |
| formulation utilizing | hypromellose matrix | uses an | achieves the |
| a controlled-release | in Glucophage XR | immediate- | controlled-release |
| polymer matrix | controls the release | release | through the matrix |
| | rate of Metformin | formulation that | system. Januvia lacks |
| | | does not control | this system, meaning |
| | | release | it does not achieve |
| | | | sustained release. |
| Relevant: | | | |
| The formulation | Yes-Glucophage | No-Januvia | Glucophage XR is |
| must reduce | XR allows for once- | requires multiple | highly relevant, as it |
| frequency of | daily dosing, | doses daily due to | meets the claim's |
| administration | reducing | its immediate- | requirement for |
| compared to | administration | release | reducing dosing |
| immediate-release | frequency | formulation | frequency. Januvia is |
| tablets | | | not relevant in this |
| | | | context. |
| Time-Bound: | | | |
| The formulation | Yes-Glucophage | No-Immediate | Glucophage XR |
| must maintain | XR provides | release is | satisfies the time- |
| therapeutic effect | sustained release | metabolized | bound element, |
| for at least 12 hours | for 12+ hours, | rapidly, failing to | ensuring sustained |
| | aligning with the | maintain | release over 12 |
| | claim's time | therapeutic levels | hours. Januvia does |
| | requirement | for an extended | not meet the time |
| | | period | requirement. |

Glucophage XR is a relevant comparable product, meeting all elements of claim 7 for a sustained-release formulation using a hydrophilic matrix that controls release over an extended period. Januvia does not meet the claim, as it lacks a controlled-release mechanism and only offers immediate release, which does not fulfill the sustained-release or extended therapeutic period requirements.

### Example 3

Patent: Chemotherapy Agent for HER2-Positive Breast Cancer

| | | Kadcyla (Ado- | |
|---|---|---|---|
| Claim 5 | Herceptin | trastuzumab | Additional |
| Elements | (Trastuzumab) | emtansine) | Observations |
| conjugated | Yes-Herceptin | Yes-Kadcyla | Herceptin does not |
| with a | (SMILES: | (SMILES: | meet this element |
| cytotoxic | CC1═CC(═O)N2C═C(C | CC1═CC(═O)N2C═C(C | as it is not |
| agent | (═O)N2C(═O)N1C(═O) | (═O)N2C(═O)N1C(═O) | conjugated to a |
| specifically | C)C2═C1C(C(═O)N) is | C)C2═C1C(C(═O)N) | cytotoxic agent. |
| targeting | an antibody targeting | targets HER2-positive | Kadcyla meets the |
| HER2 | HER2 (human | cells, conjugated with | claim by |
| receptor | epidermal growth factor | DM1 (a cytotoxic | conjugating the |
| overexpression | receptor 2) on cancer | agent, SMILES: | HER2-targeting |
| | cells, but not | CC1═CC(═O)N2C═C(C | antibody with a |
| | conjugated with a | (═O)N2C(═O)N1C(═O) | cytotoxic agent |
| | cytotoxic agent. | C)C2═C1C(C(═O)N), | (DM1). |
| | | for enhanced | |
| | | targeting of tumor | |
| | | cells. | |
| significant | No-Herceptin alone is | Yes-Kadcyla delivers | Herceptin alone |
| cytotoxic | an antibody therapy | the cytotoxic agent | does not meet the |
| activity | that blocks HER2 | DM1 to HER2- | measurable |
| specifically in | activity but does not | expressing cells, | cytotoxic activity |
| HER2- | directly induce | leading to significant | requirement, |
| overexpressin | cytotoxicity. | tumor cell killing. | whereas Kadcyla |
| g cancer cells | | | fulfills this by |
| | | | conjugating a |
| | | | cytotoxic agent to |
| | | | target HER2- |
| | | | positive cancer |
| | | | cells. |
| selectively | No-Herceptin binds to | Yes-Kadcyla | Herceptin does not |
| bind to HER2 | HER2 but does not | specifically binds to | release a cytotoxic |
| receptors and | release a cytotoxic | HER2 receptors on | agent, unlike |
| release the | agent. | cancer cells and is | Kadcyla, which |
| cytotoxic | | internalized to release | meets the |
| agent inside | | DM1, ensuring | achievable element |
| the cancer cell | | targeted therapy. | by delivering the |
| | | | drug directly to |
| | | | HER2-expressing |
| | | | tumor cells. |
| prolonged | No-Herceptin does | Yes-Kadcyla's | Herceptin does not |
| therapeutic | not contain a sustained | conjugation of DM1 | meet the time- |
| effects | release mechanism for | ensures a prolonged | bound |
| through | a cytotoxic agent. | therapeutic effect by | requirement, |
| sustained | | releasing the cytotoxic | whereas Kadcyla |
| delivery of the | | agent over time to | provides sustained |
| cytotoxic | | continuously target | delivery due to the |
| agent | | HER2-positive cells. | cytotoxic agent's |
| | | | conjugation. |

Herceptin (Trastuzumab) does not fully meet the elements of claim 5 because it does not conjugate a cytotoxic agent, nor does it provide direct cytotoxicity to cancer cells. Kadcyla (Ado-trastuzumab emtansine), however, meets all the requirements of claim 5, as it includes a HER2-targeting antibody conjugated with a cytotoxic agent 2 (DM1) that is selectively delivered to and internalized by HER2-positive cancer cells, resulting in enhanced therapeutic efficacy and prolonged therapeutic effects.

### Example 4

Patent: Wireless Charging Pad with Overheat Protection (Claim 10)

| Claim 10 Elements | Apple MagSafe Charger | Basic Qi Wireless Charger |
|---|---|---|
| Wireless power transfer | Yes-Uses Qi-standard | Yes-Uses Qi-standard |
| using inductive coupling | inductive charging with | inductive charging but lacks |
| | magnetic alignment | alignment assistance |
| Includes thermal sensor | Yes-Integrated thermal | No-No dedicated thermal |
| to monitor heat levels | sensor actively monitors | sensor; passive heat |
| | heat levels during charging | dissipation only |
| Automatically reduces | Yes-Dynamically adjusts | No-Fixed power output |
| power when overheating | power output to prevent | with no heat-regulation |
| is detected | excessive heat buildup | mechanism |
| Optimized charging | Yes-Uses device-specific | No-Provides a uniform |
| efficiency based on | power adjustments (e.g., | power output regardless of |
| device type | iPhone vs. AirPods) | the device |

The Apple MagSafe Charger meets all elements of claim 10 and is a highly relevant comparable product. The Basic Qi Wireless Charger lacks thermal protection and power adjustment, making it less relevant.

### Example 5

Patent: Adjustable Torque Wrench with Digital Display (Claim 15)

| | | Standard Click-Type |
|---|---|---|
| Claim 15 Elements | Snap-On TechAngle Wrench | Torque Wrench |
| Adjustable torque | Yes-User can adjust torque | Yes-Torque is manually |
| settings | values via digital input for | adjusted using a mechanical |
| | precision control | scale |
| Electronic display for | Yes-Features an LCD | No-No electronic display; |
| torque measurement | screen displaying real-time | uses a mechanical click |
| | torque values | system |
| Alerts user when | Yes-Provides both visual | Yes-Uses a mechanical |
| preset torque is | and auditory alerts (LED and | click mechanism, but no |
| reached | beeping sound) | visual feedback |
| Stores multiple torque | Yes-Allows users to save | No-Requires manual |
| presets | and recall torque values for | resetting for each use |
| | repetitive tasks | |

The Snap-On TechAngle Wrench meets all elements of claim 15 and is a relevant comparable product. The Standard Click-Type Torque Wrench lacks an electronic display and preset storage, making it only partially relevant.

1. A method for determining patent coverage, comprising:
interpreting a patent document using at least one first computational model trained with a collection of patent data;
generating at least one scope representation based on the interpretation, wherein said at least one scope representation comprises one or more claim elements corresponding to the patent document;
mapping said least one scope representation to a product or service using at least one second computational model trained with data on products and services in relation to the collection of patent data, wherein the mapping comprises at least one data structure associated with a claim format; and
outputting a data representation of the patent coverage for the patent document based on the mapping.

2. The method of claim 1, is further comprising: generating a data embedding corresponding to the collection of patent data based on the interpretation.

3. The method of claim 1, further comprising
receiving a patent document comprising one or more inventions; and
generating said at least one scope representation corresponding to each invention in the patent document.

4. The method of claim 1, further comprising:
aggregating the data representation of the patent coverage for a plurality of patent documents;
consolidating said mapping based on overlap of said least one scope representation for the same product or service; and
outputting a data representation of the patent coverage based on the consolidated mapping for the plurality of patent documents.

5. The method of claim 1, further comprising:
performing a search for the product or service based on said at least one scope representation using said at least one second computational model; and
identifying a corpus of documents associated with the product or service according to the search based on the contextual relevance of each document in the corpus to said at least one scope representation.

6. Method of claim 5, wherein said at least one second computational model is configured to encode the product or service information based on the claim format; and/or updating said at least one second computational model with the corpus of documents.

7. The method of claim 1, further comprising:
obtaining a corpus of documents based on said at least one second computational model;
identifying at least one product or service from a predetermined list of products or services based on an analysis of the corpus of documents, wherein the said at least one product or service is contextually relevant to said at least one scope representation based on an assessment made by at least one second computational model of the corpus of documents and said at least one scope representation in accordance with the analysis; and
classifying said at least one product or service based on the assessment; and identifying the product or service based on the classification.

8. The method of claim 7, further comprising:
analyzing the corpus of documents according to the predetermined list of products or services; and/or assessing the patent coverage of the patent document based on the mapping.

9. The method of claim 1, wherein said at least one first computational model comprises one or more language models configured to conduct contextual searches from one or more sources; and/or wherein said at least one first computational model comprises said at least one second computational model.

10. The method of claim 1 wherein said obtaining at least one scope representation, further comprising:
generating at least one data structure associated with a claim format based on one or more patent claims in the patent document, wherein the data structure comprises one or more vector representations of one or more patent claims; and
obtaining said at least one scope representation based on said at least one data structure, wherein each invention scope corresponds to a claim format.

11. The method of claim 10, further comprising:
consolidating said at least one data structure under one or more classifications; and
obtaining said at least one scope representation based on the consolidating said at least one data structure in relation to said one or more classifications.

12. The method of claim 10, wherein the claim format comprises a claim chart or graph.

13. The method of claim 1, wherein the search is based on one or more patent claims in the patent document, prioritized based on relevance between said at least one scope representation associated with said one or more patent claims and contextual 17 information from one or more sources.

14. The method of claim 1, wherein the corpus of documents comprises one or more disclosures associated related to the patent document.

15. The method of claim 1, further comprising:
processing said one or more claim elements in said at least one scope representation of the mapped product or service using at least one computational technique with respect said at last one first computational model, wherein the computational technique comprises one or more of rule-based logic, statistical modeling, machine learning, or artificial intelligence-based processing; and
determining a similarity measure between said one or more claim elements and the mapped product or service based on at least one of keyword matching, vector embeddings, semantic similarity analysis, context-aware inference, or a combination thereof;
adjusting contextual relevance based on at least one predefined weighting factor, wherein said at least one weighting factor is based on at least one of claim breadth, prior legal determinations, examiner citation patterns, historical enforcement data, or a combination thereof; and
normalizing the contextual relevance to facilitate ranking of products or services with respect to the mapping of the patent document.

16. The method of claim 1, further comprising:
determining a similarity measure between said one or more claim elements in said at least one scope representation of the mapped product or service using at least one of cosine similarity, term frequency-inverse document frequency, a neural network embedding-based similarity metric, or a combination thereof;
applying at least one weighting factor to prioritize said one or more claim elements based on predefined criteria, wherein the predefined criteria comprise at least one of semantic relevance, historical litigation outcomes, examiner citations, or a combination thereof; and
normalizing the computed relevance scores to facilitate ranking of products or services with respect to the patent document.

17. The method of claim 1, further comprising:
receiving the collection patent data using retrieval-augmented generation, wherein the retrieval-augmented generation is integrated to said at least first computational model that dynamically identifies and fetches relevant contextual information based on the content of the patent document;
integrating the collection patent data into said at least one scope representation to refine the contextual relevance of said one or more claim elements; and
applying the updated scope representation during the mapping and search processes to enhance the accuracy and relevance of the product or service matching with respect to said at least one second computational model.

18. A system for determining patent coverage, wherein the system comprises one or more modules, comprising:
at least one first computational model trained with a collection of patent data, wherein said at least one first computational model is configured to interpret a patent document and extract one or more claim elements;
wherein said one or more modules are configured to generate at least one scope representation based on the interpretation, wherein said at least one scope representation comprises said one or more claim elements corresponding to the patent document;
at least one second computational model trained with data on products and services in relation to the collection of patent data, wherein said at least one second computational model is configured to map said at least one scope representation to a product or service, said mapping comprising at least one data structure associated with a claim format; and
wherein said one or more modules are further configured to output a data representation of the patent coverage for the patent document based on the mapping.

19. The system of claim 18, wherein said one or more modules are configured to execute method steps according to claim 1.

20. A method for training a computational model to interpret patent coverage of a patent document, comprising:
receiving training data comprising one or more of patent documents, prior art references, publications, opinions, examination reports, and product or service catalogs;
processing the training data based on one or more criteria associated by using one or more techniques of tokenization, entity recognition, and vector embedding generation, wherein said one or more criteria comprise patent classification and technical terminology;
training the computational model using the processed training data, wherein the computational model is configured to distinguish claim elements, legal concepts, and technical descriptions, and generate a structured mapping between them, wherein the structured mapping is represented as a semantic relationship model or vector space embedding;
wherein said training the computational model comprises one or more of multi-layer attention mechanisms, transformer-based embeddings, and supervised learning with annotated patent datasets;
wherein said computational model is configured to learn based on teaching and disclosed documents cited in the examination report with respect to claim interpretation, wherein the claim interpretation learned by the computational model can be used to assess patent coverage; and
generating a trained computational model configured to interpret the patent coverage of the patent document.
